(19) United States
(12) Patent Application Publication
(10) Pub. No.: US 2009/0122358 A1
(43) Pub. Date: May 14, 2009

(54) PORTABLE USER CONFIGURATION FOR IMAGING DEVICES

(76) Inventors: Benjamin S. Moore, Georgetown, KY (US); Charles E. Grieshaber, Versailies, KY (US); Stephen F. Hunt, Lexington, KY (US); William G. Flowers, Lexington, KY (US); Nathan K. Klemperer, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/937,531

(22) Filed: Nov. 9, 2007

(51) Int. Cl. H04N 1/024

(52) U.S. Cl. 358/473

(57) ABSTRACT

User configurations are stored on a portable storage device for reuse later on an imaging device. Methods and apparatus contemplate establishing an initial configuration of identity information about the user and then creating imaging preferences, such as duplexing, overlaying, and orienting options, for a to-be-imaged media. The initial configuration and the imaging preferences are stored on the portable storage device, such as a USB flash drive. Upon interfacing of the portable storage device with the imaging device, users are queried as to whether the stored imaging preferences are to be used in imaging the to-be-imaged media (such as by presentation of a dedicated icon). If so, a controller reads the stored imaging preferences from the portable storage device and images the media accordingly. In this manner, users are uniquely outfitted with configuration options to avoid generic settings of an imaging device generally configured at the time of device installation.

### FIELD OF THE INVENTION

Generally, the present invention relates to imaging devices, such as laser printers, copy machines, scanners, fax machines, inkjet printers, all-in-ones, etc. Particularly, it relates to user configurations allowing unique creation and storage according to typical workflows. In one aspect, configurations are stored on a portable storage device for reuse later on a same or different imaging device. In another, control panels, displays and various menus relate to representative strategies for creating, storing and editing the configurations. Other noteworthy features include multiple profiles of configurations being available per each user, per one or more types of imaging devices. Various computing environments are also disclosed.

### BACKGROUND OF THE INVENTION

Both multi-function and single-function imaging devices (MFIDs and SFIDs) support a wealth of configuration options. Various configuration values may be set by a system administrator who controls how the system can be used by an end user. All users who interact with the MFID or SFID are presented with the default system configuration, as created by the administrator. Users can change the way an individual imaging job works by interacting with the workflow user interface, but this configuration is generally reset to the system default once the user finishes his/her job and the user must reenter their data per a next job. Intuitively, the continual reentry of data creates an inconvenience for end users.

Also, not all users need to interact with the imaging device in the same manner, which results in many users setting the same sorts of configuration options whenever they execute their workflow.

Accordingly, a need exists in the art of imaging devices to tailor configuration options to individual needs. It further contemplates storing these options for reuse with future imaging jobs. Having the ability to transfer the options to other imaging devices is still another consideration. Naturally, any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter-described portable user configuration for imaging devices. In a basic sense, users are uniquely outfitted with configuration options per one or more imaging devices to avoid generic settings generally configured at the time of device installation.

In a representative embodiment, user configurations are stored on a portable storage device for reuse later on a same or different imaging device. Methods and apparatus contemplate establishing an initial configuration of identity information about the user and then creating imaging preferences, such as duplexing, overlaying, and orienting options, for a to-be-imaged media. The initial configuration and the imaging preferences are stored on a portable storage device, such as a USB flash drive. Upon interfacing of the portable storage device with the imaging device, users are queried as to whether the stored imaging preferences are to be used in imaging the to-be-imaged media (such as by presentation of a dedicated icon). If so, a controller reads the stored imaging preferences from the portable storage device and images the media accordingly.

Specific imaging preferences include the above-identified preferences and others relating to faxing, scanning, pagination, or image quality, to name a few.

The imaging device also includes a control panel, including a display for interfacing with users. Various visual indicators or icons on menus of options are provided on the display to configure initial identity information and various desired copy preferences. A homepage of the display includes a visual indicator that is selectable for using the stored imaging preferences whenever the portable storage device is interfaced in a media port of the imaging device. Multiple profiles are also available per each user, per one or more types of imaging devices. Various computing environments are also disclosed.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the teachings of the present invention of an imaging device in the form of a laser printer for portable user configurations;

FIG. 2 is a diagrammatic view in accordance with the teachings of the present invention of an alternate form of an imaging device for portable user configurations;

FIGS. 3-7 are diagrammatic views in accordance with the teachings of the present invention indicating a representative strategy for creating, storing and editing portable user configurations; and

FIG. 8 is a diagrammatic view of a representative computing environment for practicing the invention.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, portable user configurations for imaging devices are hereinafter described.

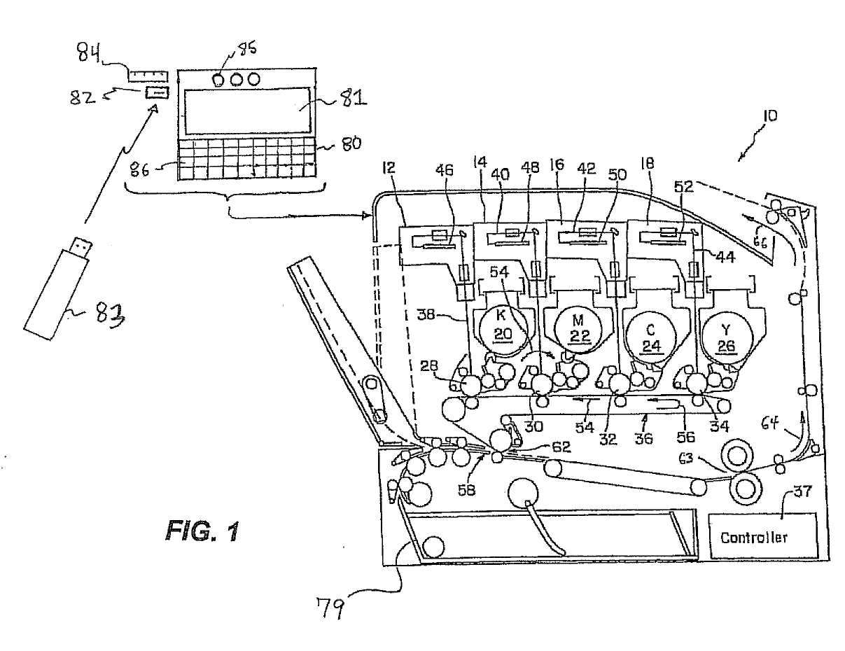

With reference to FIG. 1, a representative imaging device is typified by a laser printer indicated generally by the numeral 10. The device includes a plurality of supply items in the form of optionally removable toner cartridges 20, 22, 24 and 26 and each has a different colored toner (C, M, Y, and K). An intermediate transfer member (belt 36) is also present as are laser print heads 12, 14, 16 and 18 and one or more recording media supply trays 80. During use, each of the laser print heads projects a respective laser beam 38, 40, 42, 44 from a respective laser source 46, 48, 50 and 52. As a polygon mirror, oscillator or other scanner mechanism moves, it scans a respective reflected laser beam across a respective photoconductive drum 28, 30, 32 and 34 to create a latent to-be-printed image. The image data is received from a controller 37, in turn, supplied from an external computing device, such as a special or general purpose computer, cell phone, PDA, scanner, memory card, camera, etc.

To develop the images, toner in each of the cartridges is transferred to the photoconductive drums by appropriately biased voltages and then transferred to a media (hard copy output) or an intermediate transfer member and then to the media. In this case, toner from cartridges 20, 22, 24 and 26 is brought into contact with a respective one of photoconductive drums 28, 30, 32 and 34 which, in turn, is transferred to a belt 36 rotating in the direction indicated by arrow 56. As a print medium, such as paper, travels along path 58 from tray 79, the toner is transferred to the surface of the print medium in a nip 62. Thereafter, the media is advanced in the direction of arrows 64, 66 (and fused along the way at nip 63) to provide an output hard-copy to users.

A control panel 80 is provided for display 81 of messages, and entry of user configurations, for example. It also includes various media-ports or -slots 82 or 84, for receipt of USB flash drives, memory cards or sticks, computer readable media, etc. Various bulbs or LEDs 85 may also light to provide messages or indications to users. One or more user buttons 86 enable the user to interface with the controller to make selections, change or enter user-adjustable variables, cancel print jobs, or the like. Similar functionality may also exist in menus on a display of a computer monitor described below. The controller may be an Application Specific Integrated Circuit (ASIC), microprocessor, a collection of dedicated electronic chips, such as on a printed circuit board (PCB), or other. It may even be a collection of the foregoing.

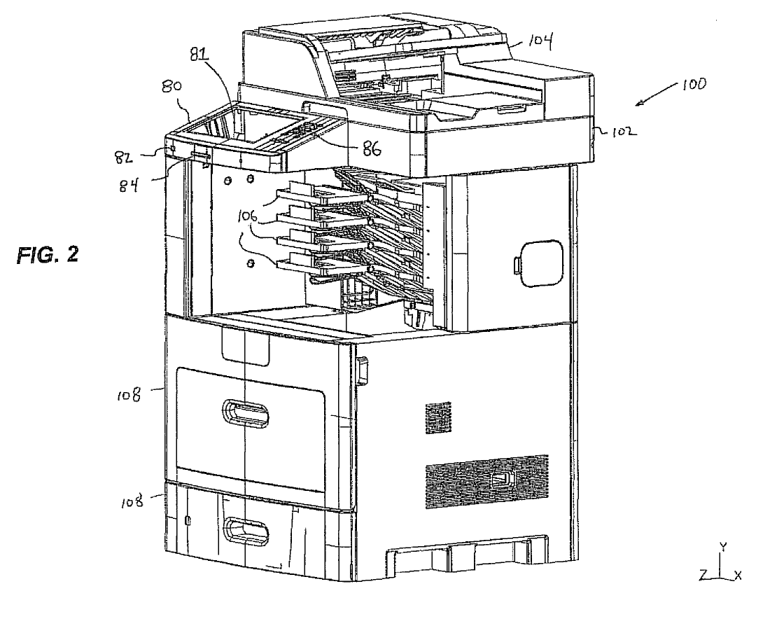

In other embodiments, the imaging device of the invention is a copy machine, fax machine, scanner, inkjet printer, or all-in-one or multi-function printer (MFP) 100 as seen representatively in FIG. 2, including a scanner 102, paper feeder 104, plural output bins 106, plural paper trays 108, etc.

Regardless of imaging device type, a high-level organization of the portable user configuration is referenced in two sections. First, a subsystem is responsible for saving and restoring user configuration data to and from a portable storage device, such as a USB flash drive 83 (FIG. 1). Second, a user-accessible application for personalizing the portable configuration data is borne out via visual indicators in various menus of the display 81.

In more detail, the save/restore functionality is based around flat file storage. All of a user's personal options are stored as simple key-value pairings in the file. The format is intended to be human-readable. Both detection of configuration and creation of a new configuration are performed automatically upon the connection of a portable storage device, e.g., especially by way of the controller 37 (FIG. 1). The file format is flexible, and can store configuration items from different systems. The file parsing is intelligent enough to recognize items that do not apply to the current system, and ignore them. For example, if a user customizes his/her imaging preferences on a color MFP, these options will be also applicable to a mono SFP version of the portable user configuration application. This means that the configuration files themselves are truly portable and applicable to any device that supports the portable user configuration.

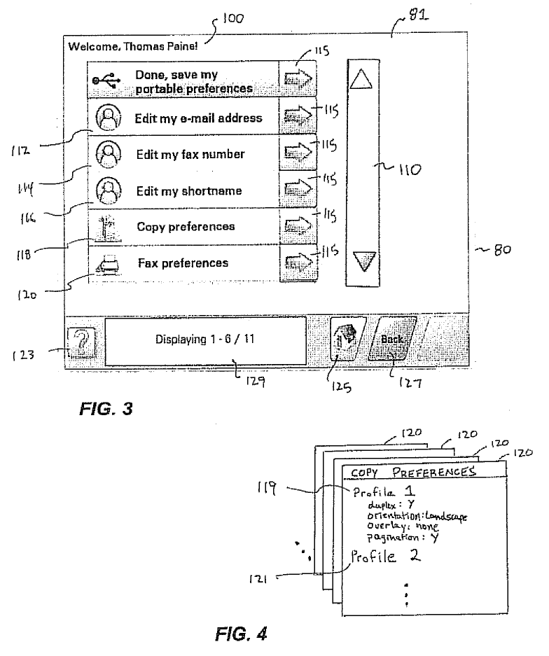

During use, upon interfacing the portable storage device with the imaging device, the storage is scanned for an existing configuration file. If the file is found, then the user's customized options are all applied to the system for imaging a next media/print job. The user is also preferably greeted with a simple welcome message (Such as “Welcome <username>” 100 (FIG. 3) for a few seconds). Alternatively, the user is queried to see if first they want to apply the customized options and, if so, they are then applied to a next to-be-imaged media/print job.

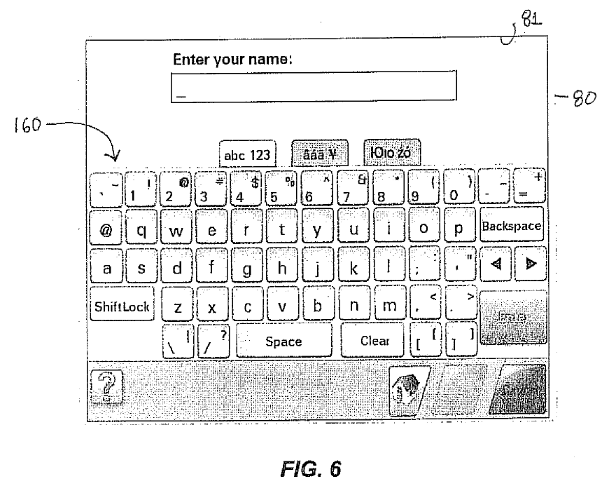

If no file is found, on the other hand, the user is prompted for whether he/she wishes to create a new set or profile of options. If the user chooses to create a new set, a few visual indicator prompts for personal identity information will be presented to the user (see FIG. 6). Items such as user name, phone number, and email address are then collected via these prompts. Once the initial configuration is complete, the configuration file is written to the storage device.

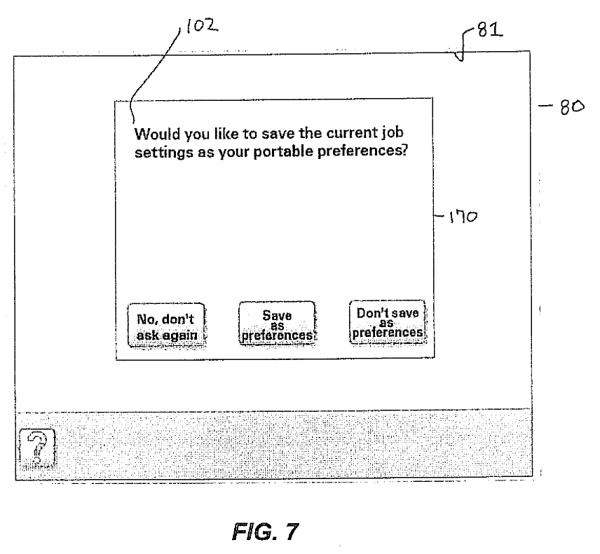

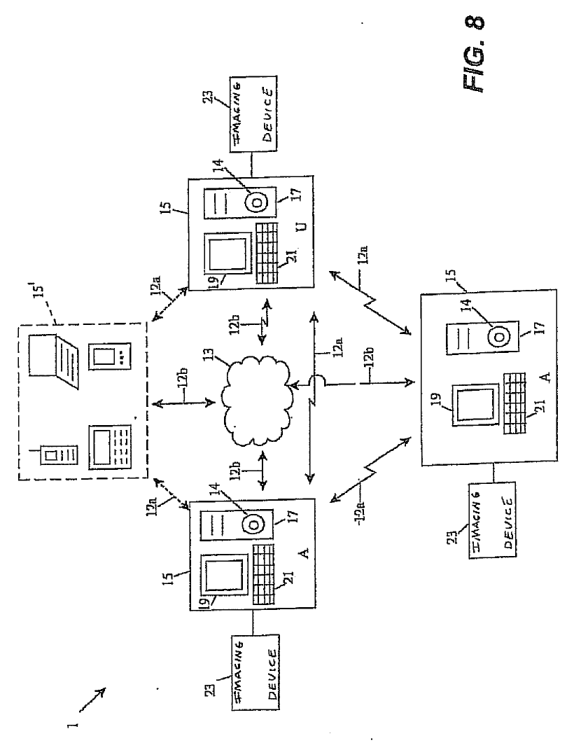

Once the user has a configuration file on his/her storage device, the user then must be able to customize the configuration to suit his/her workflow needs. This customization can be performed in one of two ways. The first is implicit configuration. That is, the user is able to change options by simply executing jobs as he/she normally would. Upon successful completion of a workflow, the user is presented with a visual indicator prompt 102 asking whether or not the recently-completed workflow's options should be saved as defaults (see FIG. 7). This simple mechanism allows users who execute the same sort of tasks very often to easily create and carry their workflow configuration with them on a small storage device, such as a compact USB flash drive.

In the second, the user's ability to customize MFP options goes beyond the simplistic, implicit approach. That is, users will have the option of executing an application which allows for broader configuration of the device. This application will be automatically installed for any user who has connected a storage device with a personalized, initial configuration file on it. When the user executes the customization application, he/she is presented with a small hierarchy of menu options that represent the settings that can be configured and persisted on the user's portable storage device.

With reference to FIG. 3, the above is representatively implemented via menu of options with various visual indicators that are scrolled-through by the functionality of a scroll bar 110 on the display 81. In a first option, selection of “Edit my e-mail address” 112 takes users to a second screen shot where they are presented with the email address of record and an ability to type a new or updated address. Similarly, the options for “Edit my fax number” 114 and “Edit my shortname” 116 consists of taking users to a next screen shot (via the functionality of the appropriate arrow icon 115), whereby users simply enter the fax number or shortname they desire.

In another option, “Copy preferences” 118 takes users to one or more screen shots 120 (FIG. 4) where they enter representative data about the following options: numbers of printing pages; duplexing options, such as yes/no and to which page numbers it applies; overlaying options, such as “Confidential,” “Draft,” “Date/Time,” etc.; orientation, such as Landscape, portrait or rotate 180°; image quality, such as resolution; scaling, such as shrink-to-fit or specific percentages; pages per sheet; paper size, such as 8.5″×11″ or A4, etc., tray source; or other well known or hereafter-invented copy preferences. Also, the “copy preference” option can consist of multiple other screen shots where users enter their unique preferences and such are storable as one or more profiles 119, 121 (FIG. 4) where specific options can be mixed and matched to give users multiple pre-set selections of options at their disposal. To the extent the user enters a new profile, establishes an entirely new set of options, or sets one profile as a default in lieu of another, the user can be queried as to whether they desire to save the new profile/options. If so, they are then saved to the portable storage device.

In still another option, “Fax preferences” 120 takes users to one or more representative screen shots where they indicate their preferences for faxing options, such as one or more of the above, plus a to-be-faxed-to number, source origination fax number, time stamps, etc.

Although not shown, still other options for portable user configurations consist of, but are not limited to, “Import my address book,” “Set my homepage background image,” “Change icons on my homepage,” etc.

Naturally, other visual indicators are provided on the control panel 80 for further imaging device functionality. E.g., the “?” icon 123 can be selected to received “help” information; the house icon 125 can be selected to return to a homepage; the “back” icon 127 can be selected as users maneuver through the many pages, per each of many options, which are displayed at 129; or the like.

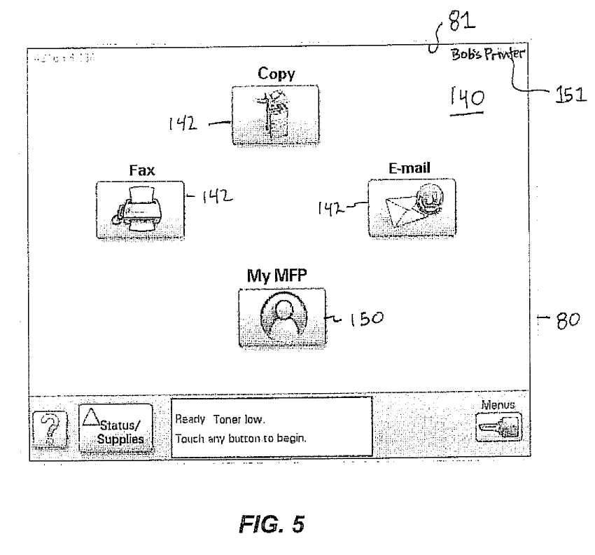

With reference to FIG. 5, another embodiment of the invention contemplates a homepage 140 on the display of the imaging device that presents various visual indicators or icons 142 that can be selected by the user for various imaging jobs. However, as a feature to let users know that their portable storage device is properly interfaced with a media slot of the imaging device, and their imaging preferences (e.g., options of “Copy Preference” 118, FIG. 3) are available for use in a given imaging job, the visual indicator 150 (“My MFP,” in this instance) appears on the homepage, as does a welcome message 151 (i.e., Bob's Printer). Otherwise, only icons 142 appear.

To establish initial identity information parameters about the user, or anytime specific entries other than a pre-settable default are required by a user, FIG. 6 teaches a touch-screen-style typing keypad 160 on the display 81 for the user to enter letters, symbols, etc.

With reference to FIG. 7, if the stored imaging preferences of the portable storage device are not to be used in imaging a next to-be-imaged media, the user may be queried to enter new options. To the extent the user would like to save such new options, a Q/A screen 170 can appear that requires a simple selection. Alternatively, if the user images a media without regard to their saved preferences, the Q/A may inquire whether they want to save those options, most-recently used, on the portable storage device.

With reference to FIG. 8, a representative computing environment 1 for portable user configurations in a network includes one or more computing devices 15 or 15′ available per users. In a traditional sense, an exemplary computing device typifies a server 17, such as a grid or blade server, or peer-to-peer arrangement etc. Alternatively, an exemplary computing device includes a general or special purpose computing device in the form of a conventional fixed or mobile computer 17 having an attendant monitor 19 and user interface 21. The computer internally includes a processing unit for a resident operating system, such as DOS, WINDOWS, MACINTOSH, VISTA, UNIX and LINUX, to name a few, a memory, and a bus that couples various internal and external units, e.g., imaging device 23, to one another. In addition, other items (also available per each of the users) include, but are not limited to, PDA's, cameras, scanners, microphones, joy sticks, game pads, satellite dishes, hand-held devices, consumer electronics, minicomputers, computer clusters, main frame computers, a message queue, a peer machine, a broadcast antenna, a server, a grid-computing node, a virtual machine, a web service endpoint, a cellular phone or the like. The other items may also be stand alone computing devices 15′ in the environment 1.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., code or software, as part of computer program products on readable media, e.g., disk 14 for insertion in a drive of computer 17, such as an imaging device or printer driver. Computer executable instructions may also be available as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be any available media, such as RAM, ROM, EEPROM, CD-ROM, DVD, or other optical disk storage devices, magnetic disk storage devices, floppy disks, or any other medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T1 lines, satellites, microwave relays or the like. The connections may be local area networks (LAN), wide area networks (WAN), and/or metropolitan area networks (MAN) that are presented by way of example and not limitation. The topology is also any of a variety, such as ring, star, bridged, cascaded, meshed, or other known or hereinafter invented arrangement.

With the foregoing in mind, skilled artisans will readily contemplate additional functionality. For example, information technology (IT) or other system administrator-type personnel of an enterprise may receive log/audit reports about certain users (according to their portable user configurations) as to how many copies they make, how often they image, how much toner or ink is expended, whether imaging occurs in color or black/white, etc. To accomplish this, the controller merely tracks the users' habits and stores them for later generation by the IT person or sends alerts, such as emails.

Certain advantages of the invention over the prior art should now be readily apparent. For example, users are uniquely outfitted with configuration options per one or more imaging devices to avoid generic settings generally configured at the time of device installation. Also, the stated problems of the prior art are overcome by features of the invention that, to name a few: tailor configuration options to individual needs; store or save these options for reuse with future imaging jobs; and provide the ability to transfer the options to other imaging devices.

Finally, one of ordinary skill in the art will recognize that still further embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures. The present invention is not limited except as by the appended claims.

What is claimed:

1. A method of utilizing an imaging device with portable configurations for a user, comprising:
establishing an initial configuration of identity information about the user of the portable configurations;
creating imaging preferences for the user, including duplexing, overlaying, and orienting options for a to-be-imaged media in the imaging device;
storing the imaging preferences for the user on a portable storage device; and
upon interfacing of the portable storage device with the imaging device, imaging the to-be-imaged media according to the stored imaging preferences.

2. The method of claim 1, wherein the creating imaging preferences further includes presenting the options to the user by way of a display of the imaging device, and having the user indicate selections.

3. The method of claim 1, wherein the creating imaging preferences further includes creating faxing, scanning, pagination or image quality options for the to-be-imaged media.

4. The method of claim 1, further including inquiring whether the user desires to save imaging options of a most-recent imaging job as the stored imaging preferences.

5. The method of claim 1, wherein the interfacing the portable storage device with the imaging device further includes inserting a USB flash drive in a USB media port of the imaging device.

6. The method of claim 1, wherein the imaging device includes a display with a homepage, further including presenting a visual indicator on the homepage for using the stored imaging preferences only upon the portable storage device being interfaced with the imaging device.

7. The method of claim 1, wherein the storing the imaging preferences for the user on the portable storage device further includes presenting a visual indicator to the user that becomes selected upon the user agreeing to the options for the to-be-imaged media.

8. A method of utilizing an imaging device with portable configurations for a user, comprising:
establishing an initial configuration of identity information about the user of the portable configurations;
creating imaging preferences for the user, including duplexing, overlaying, and orienting options for a to-be-imaged media in the imaging device;
storing the initial configuration and the imaging preferences for the user on a portable storage device;
upon interfacing of the portable storage device with the imaging device, inquiring of the user whether the stored imaging preferences are to be used in imaging the to-be-imaged media; and
if so, reading the stored imaging preferences from the portable storage device and imaging the to-be-imaged media according to the stored imaging preferences.

9. The method of claim 8, wherein if the stored imaging preferences of the portable storage device are not to be used in imaging the to-be-imaged media, establishing a new set of imaging options.

10. The method of claim 9, further including inquiring whether the user desires to save the new set of imaging options.

11. The method of claim 10, further including establishing a plurality of profiles of options and storing the plurality of profiles of options on the portable storage device for selection by the user in order to image the to-be-imaged media.

12. The method of claim 8, wherein the creating imaging preferences further includes presenting the options to the user by way of a display of the imaging device, and having the user indicate selections.

10. The method of claim 8, wherein the creating imaging preferences further includes creating faxing, scanning, pagination or image quality options for the to-be-imaged media.

11. The method of claim 8, wherein the interfacing the portable storage device with the imaging device further includes inserting a USB flash drive in a USB media port of the imaging device.

12. The method of claim 8, wherein the imaging device includes a display with a homepage, further including presenting a visual indicator on the homepage for using the stored imaging preferences only upon the portable storage device being interfaced with the imaging device.

13. An imaging device for imaging a to-be-imaged media comprising:
a control panel for communicating with a user;
a portable storage device media-port for receipt of a portable storage device having stored thereon a plurality of imaging preferences for the user relative to the to-be-imaged media, the imaging preferences including duplexing, overlaying, and orienting options; and
upon interfacing of the portable storage device with the imaging device, a controller configured to inquire of the user via the control panel whether the stored plurality of imaging preferences are to be used in imaging a next to-be-imaged media; and
if so, the controller configured to read the stored plurality of imaging preferences from the portable storage device and to cause imaging of the next to-be-imaged media according to the stored plurality of imaging preferences.

14. The imaging device of claim 13, further including a display on the control panel, wherein the controller is further configured to present a visual indicator to the user only upon the proper interfacing of the portable storage device with the media-port and the selection of the visual indicator by the user answers the inquiry as to whether the stored plurality of imaging preferences are to be used in imaging the next to-be-imaged media.

15. The imaging device of claim 13, further including a scanner, wherein the controller is her configured to cause storage of imaging preferences on the portable storage device relative to scanning options.

16. The imaging device of claim 13, further including a port for connection to a phone line or the internet, wherein the controller is further configured to cause storage of imaging preferences on the portable storage device relative to faxing options.

17. The imaging device of claim 13, wherein the controller is further configured to inquire via the control panel whether the user desires to save imaging options of a most-recent imaging job.

18. The imaging device of claim 14, wherein the control panel includes the display with a displayable homepage, wherein the controller is further configured to present the visual indicator on the homepage.

19. The imaging device of claim 13, wherein the control panel includes a display, wherein the controller is further configured to present visual indicators on the display that the user selects when establishing the plurality of imaging preferences.

20. The imaging device of claim 13, wherein the control panel includes a display, wherein the controller is further configured to present a typing keypad on the display for the user to enter initial configurations establishing identity information about the user.
